(19) United States
(12) Patent Application Publication
(10) Pub. No.: US 2019/0023574 A1
(43) Pub. Date: Jan. 24, 2019

(54) METHOD FOR PRODUCING A LITHIUM BATTERY MATERIAL, MATERIALS AND LITHIUM BATTERY

(71) Applicants: UNIVERSITÉ CLERMONT AUVERGNE, Clermont-Ferrand (FR); CENTRE NATIONAL DE LA RECHERCHE SCIENTIFIQUE - CNRS, Paris Cedex 16 (FR)

(72) Inventors: Marc DUBOIS, Metz (FR); Katia GUÉRIN ARAUJO DA SILVA, Pont-du-Château (FR); Élodie DISA-SAINTON, Clermont-Ferrand (FR)

(21) Appl. No.: 15/765,390

(22) PCT Filed: Sep. 29, 2016
(86) PCT No.: PCT/FR2016/052497

§ 371 Date: Aug. 10, 2018

(30) Foreign Application Priority Data
Oct. 2, 2015 (FR) 1559378

(51) Int. Cl. C01B 32/168; C01B 32/10; H01M 10/052; H01M 4/583; H01M 4/587; H01M 6/16

(52) U.S. Cl. CPC C01B 32/168; C01B 32/10; H01M 10/052; H01M 2220/30; H01M 4/587; H01M 6/16; H01M 4/5835

(57) ABSTRACT

Some embodiments relate to a process of manufacturing a material for a lithium battery with enhanced or improved electrochemical characteristics, to the materials that can be obtained by the process of some embodiments, to an electrode incorporating a material of some embodiments, to a battery, in particular a lithium battery, incorporating a material of some embodiments, as well as to the devices incorporating a lithium battery according to some embodiments. Some embodiments can be applied in the manufacture of lithium batteries.

### CROSS REFERENCE TO RELATED APPLICATIONS

This application is a national phase filing under 35 C.F.R. § 371 of and claims priority to PCT Patent Application No. PCT/FR2016/052497, filed on Sep. 29, 2016, which claims the priority benefit under 35 U.S.C. § 119 of French Patent Application No. 1559378, filed on Oct. 2, 2015, the contents of each of which are hereby incorporated in their entireties by reference.

### BACKGROUND

Some embodiments relate to a method of manufacturing a material for a lithium battery, to the materials that can be obtained by the process of some embodiments, and to a battery, in particular a lithium battery, as well as to the devices incorporating a battery, in particular a lithium battery.

In the description below, the reference numerals between square brackets ([ ]) refer to the list of references given at the end of the text.

It is of scientific and industrial interest to further improve or enhance the electrochemical properties of electrical batteries, in particular lithium batteries, in order to obtain ever greater capacities, energies, powers and lives, above all in the current economic and ecological context.

With an objective of capacity, the strategy of some market players has been to increase the fluorination rate x in CFx in order to reach or even slightly exceed CFI, the precursors being inexpensive graphite or petroleum cokes. The method of fluorination is the reaction with molecular fluorine F₂ at high temperatures, usually 500 to 600° C. in the case of the graphite precursor. By this synthesis, the defect rate generated is high for cokes and the faradic yield of the battery is below 100%. Furthermore, the implementation procedures are costly.

The use of controlled fluorination methods, which are described in the following documents:
Zhang et al., New synthesis methods for fluorinated carbon nanofibres and applications, Journal of Fluorine Chemistry, 131, 2010, 676-683 [1]; Carbon nanofibres fluorinated using TbF4 as fluorinating agent. Part II: Adsorption and electrochemical properties, Carbon, 46, 2008, 1017-1024 [2]; Zhang et al., Carbon nanofibres fluorinated using TbF4 as fluorinating agent. Part I: Structural properties, Carbon, 46, 2008, 1010-1016 [3];
   or bi-fluorination methods, which are described in the following documents:
Synthesis and Characterization of Highly Fluorinated Graphite Containing sp² and sp³ Carbon, K. GUERIN, J. P. PINHEIRO, M. DUBOIS, Z. FAWAL, F. MASIN, R. YAZAMI & A. HAMWI, Chemistry of Materials, 16 (2004) 1786-1792 [4]; NMR and EPR studies of room temperature highly fluorinated graphite heat-treated under fluorine atmosphere, M. DUBOIS, K. GUERIN, J. P. PINHEIRO, F. MASIN, Z. FAWAL & A. HAMWI, Carbon, 42(10) (2004) 1931-1940 [5];
   limits the defect rate. However, these methods are costly and difficult to implement.

The use of nanometric forms of carbon also encourages the diffusion of ions during electrochemical processes.

By controlling fluorination, decomposition under a fluorine atmosphere, which always competes against fluorination at high temperatures, can be limited. This decomposition produces perfluorinated volatile species CF₄, C₂F₆ and hence results in a loss of both fluorine and carbon.

### SUMMARY

Therefore, it may be advantageous to identify new materials that will address or overcome some or all of the flaws, drawbacks and obstacles of the related art; in particular, a process enabling cost reduction and improved or enhanced electrochemical properties of electrical batteries must be developed.

Some embodiments address or solve the above-mentioned problems by providing a process of manufacturing a material for an electrochemical cell enabling a material to be obtained that has enhanced or improved electrochemical capacities.

Some embodiments include: grinding fluorinated carbon nanofibres (CNFs) having the formula CFx with 0.2<x<1, the grinding being achieved by frictional impacts for a period of 2 to 100 hours, for example of 2 to 10 hours, with a grinding pressure on the particles ranging from 0.29×10⁶ Pa to 4.8×10⁶ Pa, for example from 0.31×10⁶ Pa to 3.2×10⁶ Pa, for example from 0.8×10⁶ Pa to 2.4×10⁶ Pa, for example from 0.8×10⁶ Pa to 1.6×10⁶ Pa, for example from 0.8×10⁶ Pa to 1.2×10⁶ Pa.

Fluorinated carbons, having a chemical composition CFx with x<1, used in the related art particularly as a lithium battery electrode, have a maximum theoretical capacity of less than 865 mAh/g linked to the rupture of C—F bonds and the reduction of carbon atoms, the limit corresponding to the highest fluorination rate, namely a composition C/F=1. This limit has recently been largely exceeded, as described in the document Ahmad et al, “Pushing the theoretical limit of Li—CFx batteries using fluorinated nanostructured carbon nanodiscs,” Carbon, 94 (2015) 1061-1070 [6], but by implementing a second electrochemical phenomenon consuming lithium for the formation of a species intercalated in neoformed carbon by electrochemical defluorination. This second electrochemical phenomenon is only possible if the carbonaceous matrix has reconstructed itself around a reinforcement such as, for example, a central tube for nanotubes or a central disc for carbon nanodiscs, which requires a more complex process and additional costs. Furthermore, more lithium is consumed.

The inventors of the presently disclosed subject matter unexpectedly observed that the electrochemical performance of some fluorinated materials is enhanced or improved simultaneously in terms of potential discharge (increased), discharge profile (reduced or even no initial ohmic drop), energy density (increased) and capacities with values that have been measured at nearly 300% times higher than that of the original fluorinated material when the fluorinated material is subjected to grinding.

The inventors of the presently disclosed subject matter therefore experimentally studied the grinding of fluorinated carbon nanofibres and have developed the process of some embodiments. They have observed from numerous experiments carried out that the process of some embodiments in fact has the effect of opening up the carbon nanofibres in the material. Some embodiments of the presently disclosed subject matter are therefore the very first to have in some way created an intrinsic reinforcement of the material, in the sense previously described as regards extra capacity, thanks to the process of some embodiments, by mechanically grinding the fluorinated carbon nanofibres.

For example, in an electrochemical battery or cell, the enhancement of improvement of the electrochemical properties of the fluorinated material by the process of some embodiments enables an enhancement or improvement in battery life. Generally speaking, when the fluorination rate x in CFx increases, the material becomes less and less electronically conductive. At x>0.7, the fluorinated carbon is insulating leading to an ohmic drop at the start of discharge of the battery. Electrochemical defluorination during the operation of the battery then forms conductive carbon and the potential increases.

The experimental results achieved by the inventors of the presently disclosed subject matter show that the material obtained by the process of some embodiments enables this conduction from the very start of the discharge, and the ohmic drop is thus reduced or even eliminated. Overvoltage is also reduced throughout the discharge, increasing the energy density in synergy with the increase in capacity.

Thus, some embodiments also relate to a material of an electrochemical cell that can be obtained by the process of some embodiments.

According to some embodiments, the grinding by frictional impact can be performed using beads or balls, for example as described in the examples below. According to some embodiments, “frictional impact” or “impact and friction” refer to an interaction that opposes the relative movement between two systems in contact. The grinding according to some embodiments can be performed using any appropriate methods to carry out some embodiments, known by one of ordinary skill in the art, for example using a planetary ball mill or using an impact crusher with beads.

According to some embodiments, grinding can be performed under a vacuum or under an atmosphere chosen from a neutral atmosphere, possibly fluorinated, advantageously or preferably under an argon atmosphere, possibly fluorinated.

According to some embodiments, grinding can for example be performed at a temperature ranging from 0 to 15° C. and 55 to 60° C., i.e., the lower boundary of this temperature range being between 0 and 15° C., and the upper boundary of this temperature range being between 55 and 60° C. The temperature may for example be from 15 to 35° C.

According to some embodiments, the fluorinated carbon nanofibres having the formula CFx with 0.2<x<1 used for implementing some embodiments can be obtained by any process known to a person of ordinary skill in the art. The fluorination methods that can be used may, for example, involve fluorinating agents known to a person of ordinary skill in the art, chosen for example from F₂, a solid fluorinating agent, etc. The fluorination methods that can be used may, for example, include one of those described in the following documents: Carbon nanofibres fluorinated using TbF4 as fluorinating agent [2]; Zhang et al, Carbon nanofibres fluorinated using TbF4 as fluorinating agent [3] or Zhang et al, New synthesis methods for fluorinated carbon nanofibres and applications [1].

These non-fluorinated nanofibres are also commercially available. For example, they may be materials marketed by the MER Corporation (US), under commercial reference Catalog#MRCSD or any other equivalent material.

According to some embodiments, the fluorinated carbon nanofibres that can be used to implement the process of some embodiments can for example have a diameter of 50 to 200 nm, advantageously or preferably from 110 to 170 nm, and a length from 5 to 20 μm, advantageously or preferably from 5 to 9 μm.

According to some embodiments, advantageously or preferably, the central non-fluorinated carbon part represents from 3 to 65% of the volume of nanofibres, advantageously or preferably from 10 to 60%, for example to 20 and 53%, for example for materials CF_{0.68} to CF_{0.31}.

According to some embodiments, advantageously or preferably, the ¹³C MAS NMR spectrum has a chemical shift band of 120 to 135 ppm/tetramethylsilane (TMS).

According to some embodiments, the grinding step can advantageously include an alternation of periods of grinding (B) and pausing (P) without grinding. This alternation according to some embodiments can also be regarded as being a succession of grinding cycles each including a period of grinding (B) and a pause (P) without grinding, P and B being as defined above.

According to some embodiments, the experiments performed by the inventors of the presently disclosed subject matter involved, for example, an alternation or one or more cycles including:
a period of grinding (B) from 1 second to 100 hours, for example from 1 second to 50 hours, for example from 1 second to 20 hours, for example from 1 second to 10 hours, for example from 1 second to 5 hours, for example from 1 second to 1 hour, for example from 1 second to 30 minutes, for example from 1 second to 20 minutes, for example from 1 second to 15 minutes, for example from 30 seconds to 15 minutes, for example from 1 minute to 15 minutes, for example from 5 to 15 minutes, for example from 6 to 12 minutes, for example from 8 to 10 minutes, for example 9 minutes; and, respectively or regardless of the duration of the period or periods of grinding,
a period of pause (P) without grinding, for example from 1 second to 100 hours, for example from 1 second to 50 hours, for example from 1 second to 20 hours, for example from 1 second to 10 hours, for example from 1 second to 5 hours, for example from 1 second to 1 hour, for example from 1 second to 30 minutes, for example from 1 second to 20 minutes, for example from 1 second to 15 minutes, for example from 1 second to 5 minutes, for example from 30 seconds to 3 minutes, for example from 30 seconds to 2 minutes, for example 1 minute.

These experiments in fact show that this alternation of grinding and pausing, or repetition of grinding cycles according to some embodiments, unexpectedly allows further enhancement or improvement of the electrochemical performance of the materials obtained thanks to the process of some embodiments.

The process of some embodiments may further include a controlled fluorination or controlled “post-fluorination” step of the product derived from the process according to some embodiments. This step may for example be carried out like the aforementioned fluorination step. It makes it possible to boost the fluorination level of the material obtained after applying the inventive process, which leads to an increased capacity.

According to some embodiments, an analysis carried out on an example of material obtained by the process of some embodiments shows that the material of some embodiments includes three main classes of fibers that can be identified as follows:

i. those of lengths less than 1 μm,
ii. those of lengths between 1 and 3 μm, and
iii. those of lengths greater than 3 μm

The most numerous are fibers of lengths less than 1 μm which represent 50 to 70%, namely about 60%, out of all of the SEM images analyzed, those ranging from 1 to 3 μm represent from 20 to 40%, namely about 30% of the populations represented; and those greater than 3 μm represent from 5 to 15%, namely about 10% of the populations represented. This example of distribution of the main classes of fibers is given purely to illustrate an instance in the light of the experiments outlined above. If the duration of grinding varies, this distribution also varies.

Some embodiments also relate to an electrode including a material according to some embodiments.

Some embodiments also relate to a battery including a material or an electrode according to some embodiments.

According to some embodiments, the battery can be for example a lithium battery.

It may, for example, be a battery chosen from a button battery, a laboratory battery, a cylindrical battery or a spiral-wound battery.

Some embodiments also relate to a device including a battery according to some embodiments, for example a device chosen from a portable telephone, a meter, oil drilling communication equipment, a pressurized device, a low or high temperature device, a watch, a pacemaker, a drug or medication injector or a neuro-stimulator.

The exceptional properties of the materials of some embodiments make them the materials of choice for the manufacture of new generations of batteries, with enhanced or improved electrochemical properties, including for uses in difficult, or even extreme, conditions, for example under pressure or at low and high temperatures.

Other advantages will emerge to a person of ordinary skill in the art from the examples described below, illustrated by the accompanying figures, given for the purpose of illustration.

### BRIEF DESCRIPTION OF THE FIGURES

In these figures, “Qₑₓₚ” represents the experimental capacity expressed in mAh/g; “Qₜₕ” represents the theoretical capacity in mAh/g calculated by considering the fluorination rate achieved by NMR, in the manner described in document F. Chamssedine, Marc Dubois, Katia Guérin, J. Giraudet, F. Masin, D. A. Ivanov, L. Vidal, R. Yazami, and A. Hamwi, Reactivity of Carbon Nanofibers with Fluorine Gas, Chem. Mater., 2007, 19 (2), pp 161-172 [7]; the theoretical capacity “Qth” is expressed in accordance with the following equation: Qth=(96500*x)/(3.6*(12+19*x), where x corresponds to the fluorination rate F/C for a compound CFx and 12 and 19 are the molar masses of carbon and fluorine respectively.

The indications of time in hours (h) express the total grinding time when implementing the process of some embodiments; “η” represents the ratio expressed as a percentage between the theoretical capacity and the capacity measured during the experiments; “rpm” expresses the number of rotations per minute on implementing some embodiments in a grinder as described in the examples below.

FIG. 1 shows two scanning electron microscope (SEM) photographs: (a) of non-fluorinated carbon nanofibers, and (b) of fluorinated carbon nanofibers having the formula CF_{0.31} that can be used in the process of some embodiments.

FIG. 2 is a schematic representation of the nanofibers similar to the multi-wall nanotubes in FIG. 1 (FIG. 1 (a) and FIG. 1 (b) respectively).

FIGS. 3 (a) and (b) show two photographs of a material according to some embodiments observed under a scanning electron microscope at different magnifications.

FIG. 4 is a schematic representation of a battery including a material of some embodiments and enabling the electrochemical behavior of the material of some embodiments to be measured.

FIG. 5 represents a series of comparative measurements of capacity of the overall electrochemical behavior between a material CF_{0.31} of the related art used to implement some embodiments and ground materials CF_{0.31} obtained thanks to the process of some embodiments, grinding being performed under air and argon. The theoretical and corrected capacities are shown.

FIGS. 6 (a) and (b) represent respectively the ¹³C NMR characterization of nanofibers CF_{0.31} before and after grinding under air according to some embodiments, allowing the x of CFx to be measured before and after grinding according to the process of some embodiments. The deconvolution into three Lorentzian contributions is also shown with their attributions: C in C—C—F in the (C₂F)n type structure (the underscored atom is responsible for resonance), C in a covalent C—F bond (written C—F), and sp² carbon in weak interaction with a neighboring C̅—F bond (written C—F). x in CFx=S_{(C—F)}/(S_{C—F}+S_{C—F}+S_{C—C—F}), S is the integrated surface of the resonances.

FIG. 7 shows respectively the ¹³C NMR characterization of the nanofibers CF_{0.68} before (FIG. 7(a)) and after (FIG. 7 (b)) grinding, enabling the real quantity of fluorine x of CFx to be measured before and after grinding for 12 h under argon, according to the process of some embodiments. The deconvolution into two Lorentzian contributions is also shown with their attributions: C in a covalent C—F bond (written C—F) and sp² carbon in weak interaction with a neighboring C—F bond (written C—F). x in CFx=S_{(C—F)}/(S_{C—F}+S_{C—F}); S is the integrated surface of the resonances. The theoretical and corrected capacities are shown.

FIG. 8 shows a graph of general comparison of the overall electrochemical behavior of material CF_{0.68} of the related art versus CF_{0.68} obtained by the process of some embodiments, after grinding for 12 h under air or argon.

FIG. 9 shows different experimental measurements made on button batteries and laboratory batteries including a material according to some embodiments.

FIG. 10 shows the discharge curves of fluorinated nanofibers by F₂ (Δ) and by TbF₄ (or controlled fluorination) with F/C ˜0.7. The theoretical capacity is 742 mAh/g for F/C=0.7.

FIG. 11 is an image of a scanning electron microscope observation of a material according to some embodiments.

FIG. 12 shows experimental results in the form of galvanostatic discharge curves at 10 mA/g of CF_{0.43} CNFs, unground (solid curve) and ground according to the process of some embodiments under different atmospheres for 12 h at 350 rpm under a pressure of 1×10⁶ Pa (under vacuum (solid triangle)), argon (solid circle), nitrogen (diamond), post-fluorination with XeF₂ (solid square).

FIG. 13 shows experimental results in the form of galvanostatic discharge curves at 10 mA/g of CF_{0.71} CNFs, unground (solid curve) and ground, under different atmospheres for 6 h at 350 rpm under a pressure of 1×10⁶ Pa (under vacuum (solid circle)), argon (solid square), nitrogen (solid triangle).

FIG. 14 shows experimental results in the form of galvanostatic discharge curves at 10 mA/g of ground CF_{0.71} CNFs for 6 h at 350 rpm at 1×10⁶ Pa in small and large quantities (solid and dotted black curves, respectively).

### EXAMPLES

### Example 1: Examples of Implementation of the Process of Some Embodiments

In this first example, 200 mg of nanofibers (from the MER Corporation, under commercial reference MRCSD) were placed in a nickel basket positioned in the center of a one-liter passivated nickel reactor to be fluorinated by dynamic fluorination (flow of F₂ gas in an open reactor).

Dynamic fluorination was performed under a flow of pure gaseous molecular fluorine F₂ at a temperature Tf of 420° C., with a flow rate of F₂ of 25-30 ml/min for 180 minutes.

The material obtained had an atomic ratio rate F/C of 0.31 determined by NMR.

This material had been ground by a Retsch PM100 (trademark) planetary ball mill in a 50 ml stainless steel bowl with four 10 mm-diameter stainless steel balls under an argon atmosphere for 6 hours at a grinding speed of 350 rpm with 1 min pauses in grinding every 9 min.

These experiments were repeated with different starter CFx materials, with x being between 0.2 and 1. For example, in order to obtain a CFx material where x=0.68, dynamic fluorination was performed under a flow of pure gaseous molecular fluorine F₂ at a temperature Tf of 420° C., with a flow rate of F₂ of 25-30 ml/min for 180 minutes.

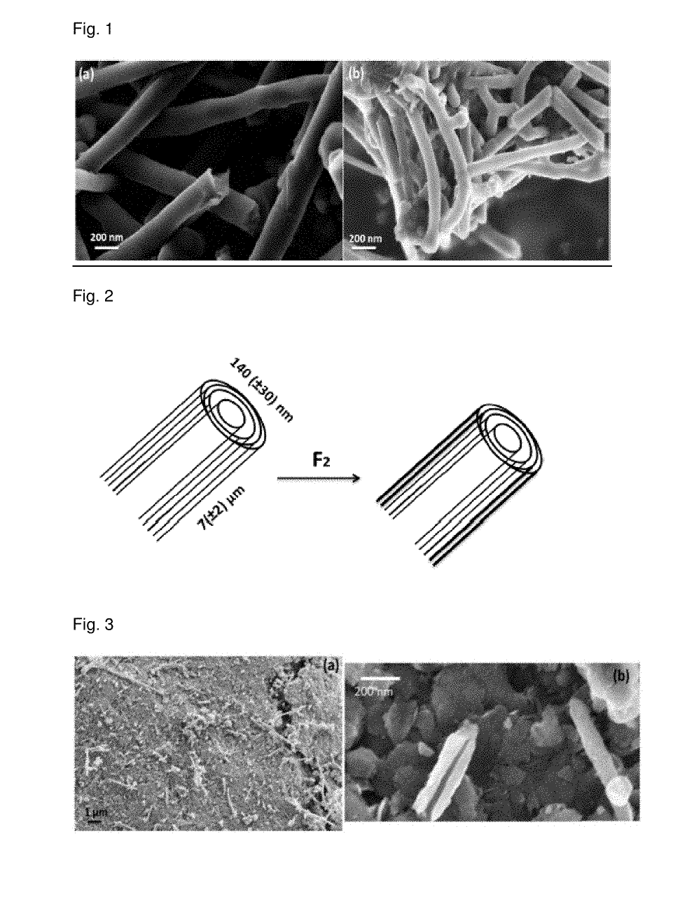

The SEM photographs in the accompanying FIG. 1 and the diagrams in FIG. 2 show nanofibers before and after fluorination.

The photographs in FIGS. 3 (a) and (b) show a material of some embodiments after implementing the process of some embodiments, at different magnifications. Studies of these micrographs are under way, but the inventors of the presently disclosed subject matter have already noted:
an altered 1D structure;
nanofibers destroyed and reduced to small flakes;
flaking of the external walls of the nanofibers in the form of isolated sheets and collections of particles;
an opening up of fibers to tend towards a nanometric 2D structure.

### Example 2: Example of the Make-Up of an Electrochemical Battery that can be Used to Implement the Material of Some Embodiments

The material obtained according to Example 1 was placed in suspension in a mixer with glass vessel by mixing with 10% by weight of polyvinylidene fluoride (PVDF) in a liquid medium of propylene carbonate.

The suspension was then deposited on the stainless steel electrode pads heated to 80° C. over a surface of around 1 cm², then the pads were degassed under primary vacuum at 120° C. for 1 hour. 50 mg of cathode material, CFx/PVDF 90/10 was obtained.

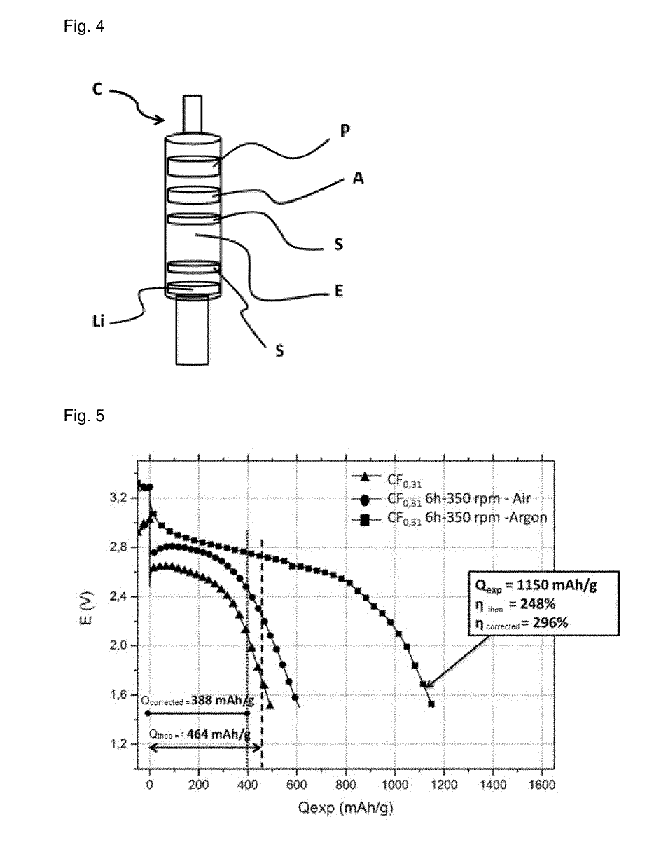

The mass of the pads was then estimated to be between 2 and 5 mg. The pads were returned to the glove box and incorporated into a laboratory lithium battery consisting of or including metallic lithium, Celgard (registered trademark) microporous separators, wetted by LiPF₆ PC/EC/3 DMC 1M electrolyte, as shown in the accompanying FIG. 4. This laboratory battery is a 304L stainless steel battery with an internal diameter of 12 mm consisting of or including a bored cylindrical body in which two 304L steel pistons slide that act as current collectors. Everything is assembled in a glove box and is perfectly sealed, adjustment screws being used to adjust the pistons in the cylindrical body.

In FIG. 4, the references correspond to the following elements of the electronic battery or cell:
C: electrochemical battery;
P: a stainless steel conductive pad;
A: the active material CFₓ;
S: separator elements which in this example are Celgard (registered trademark) membranes in the form of polymer films of polypropylene 12 mm in diameter, 25 μm thick and with an average pore diameter of 0.064 μm; and/or a Whatman (registered trademark) glass fiber disc 12 mm in diameter;
E: the electrolyte LiPF₆PC/EC/3DMC 1 M;
Li: a lithium disc.

This electrochemical laboratory cell has two stainless steel electrodes consisting of or including a piston at each end.

The battery thus constituted is taken out of the glove box and connected to a VMP2 (commercial reference) potentiated/galvanostatic made by Bio-Logic Science Instruments SAS (France). After a relaxation period of 5 h, a 10 to 20 mA/g reduction current is applied with a cut-off voltage of 1.5 V vs. Li⁺/Li.

After the period of relaxation, the battery was discharged until the stopping potential of 1.5 V and a density of 10 mA/g (reduction) or 20 mA/g.

### Example 3: Examples of Materials Obtained According to the Process of Some Embodiments and Comparisons with the Corresponding Materials of the Related Art

This example presents different experiments carried out on different materials obtained according to the process of some embodiments. In particular, the process of some embodiments used in order to obtain the materials tested in this example is that described in Example 1, and the measurements of electrochemical performance are made using a device as described in Example 2.

The variation in potential as a function of time is then measured. This duration multiplied by the current density allows the capacity to be determined. In 3 electrochemical tests performed on this material, the capacities 970, 1684 and 2339 mAh/g were obtained. The “theoretical” capacity of this material, corresponding to the capacity measured on the fluorinated carbon nanofibre material used to implement the process of some embodiments, i.e. before grinding, is 465 mAh/g. A marked phenomenon of extra capacity is therefore observed in these different experiments.

Tables I and II below summarize the experiments carried out in the context of some embodiments.

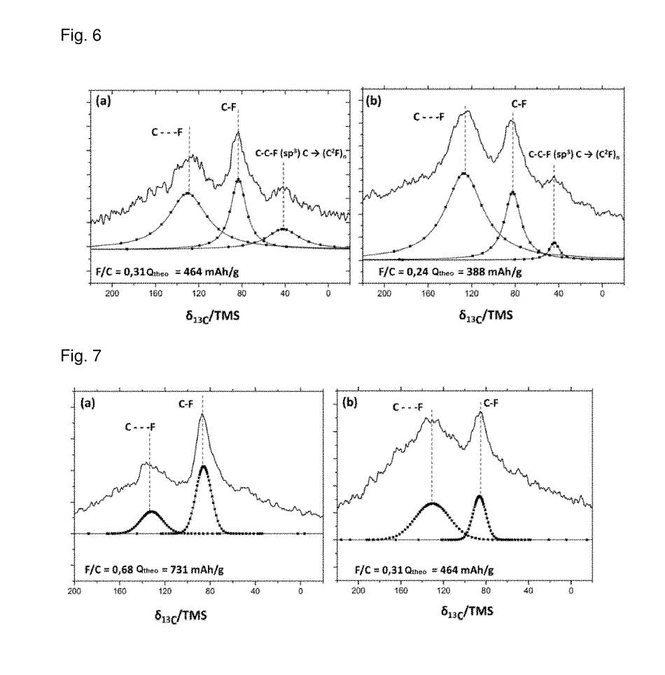

TABLE I
Examples of experiments with CF_{0.31}

| | Presentation | ¹³C NMR | |
|---|---|---|---|
| | of | Characterization | |
| | Discharge | of Fluorinated | |
| Material | Measurements | Nanofibers | Observations on the electrochemical behavior of the materials |
| CF_{0.31} nanofibers | FIG. 5 | FIG. 6 | Discharge potential at 2.5 V |
| of the related art | | | Experimental capacity of 490 mAh/g (Qth at 465 mAh/g) |
| CF_{0.31} material | FIG. 5 | — | Limited ohmic drop |
| according to some | | | Increase in the discharge potential up to 2.75 V |
| embodiments | | | Average capacity 585 mAh/g, i.e. an average experimental yield of 125% |
| obtained according | | | compared to the calculated capacity for the original composition CF_{0.31} and |
| to the process of | | | 150% compared to the calculated value for the corrected composition after |
| Example 1, | | | grinding CF_{0.24} (Q corr = 388 mAH/g) |
| grinding for 6 | | | Measured experimental capacity up to 610 mAh/g, i.e. an average |
| hours under air | | | experimental capacity of 131 and 157% of the theoretical capacity |
| | | | compared to the original (CF_{0.31}) and the corrected composition after |
| | | | grinding (CF_{0.24}) respectively |
| CF_{0.31} material | FIG. 5 | FIG. 6 | Limited ohmic drop |
| according to some | | | Increase in the discharge potential up to 2.7 V |
| embodiments | | | Average experimental capacity at 749 mAh/g for the materials of some |
| obtained according | | | embodiments, i.e. an average experimental yield of 161% compared to the |
| to the process of | | | original composition CF_{0.31} and 193% compared to the corrected |
| Example 1, | | | composition after grinding CF_{0.22} |
| grinding for 6 | | | Measured maximum capacity 1151 mAh/g, i.e. 247% of the theoretical |
| hours under argon | | | capacity Qth (CF_{0.31}) |
| | | | Measured F/C for this material of some embodiments from NMR analyses at |
| | | | 0.24, which is equivalent to a corrected theoretical capacity value Qth of |
| | | | 388 mAh/g, to be compared with the measured extra-capacity of 1151 mAh/g |
| | | | for the material of some embodiments with this same F/C ratio, i.e. at 296% |
| | | | of the reference capacity Qth_{corrected} |

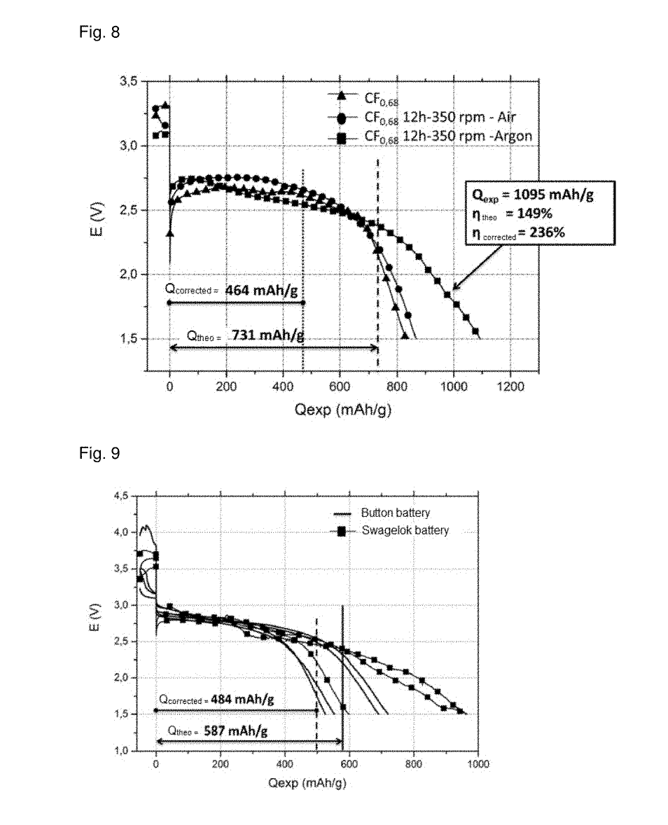

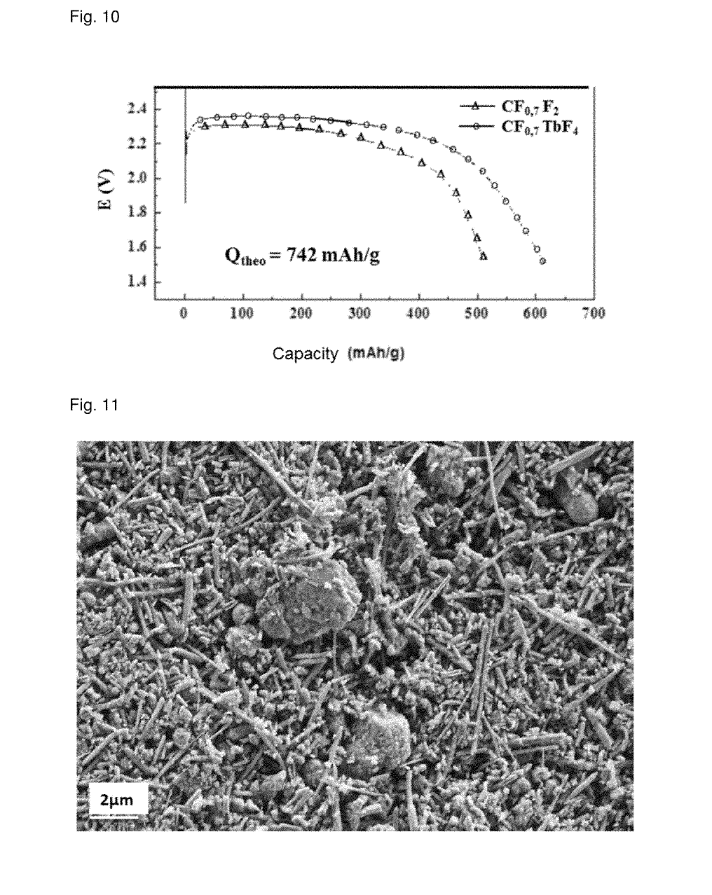

TABLE II
Examples of experiments with CF_{0.68}

| | Presentation | ¹³C NMR | |
|---|---|---|---|
| | of | Characterization | |
| | Discharge | of Fluorinated | |
| Material | Measurements | Nanofibers | Observations on the electrochemical behavior of the materials |
| CF_{0.68} nanofibers | FIG. 8 | FIG. 7 | Discharge potential at 2.2 V |
| of the related art | | | Measured capacity at 788 mAh/g for a corrected theoretical capacity at 731 |
| | | | mAh/g |
| CF_{0.68} material | FIG. 8 | — | Limited ohmic drop |
| according to some | | | Increase in the discharge potential up to 2.7 V |
| embodiments | | | Average capacity 792 mAh/g, i.e. an average yield of 108% compared to the |
| obtained according | | | theoretical capacity of a composition CF_{0.68} |
| to the process of | | | Measured experimental capacity up to 864 mAh/g, i.e. a yield of 118% |
| Example 1, | | | compared to the theoretical capacity of a composition CF_{0.68} |
| grinding for 12 | | | Considering the corrected composition after grinding CF_{0.31} and the |
| hours under air | | | corresponding theoretical capacity (464 mAh/g), the average yield is 170% |
| | | | and the maximum yield is 186% |
| CF_{0.68} material | FIG. 8 | FIG. 7 | Limited ohmic drop |
| according to some | | | Increase in the discharge potential up to 2.6 V |
| embodiments | | | Average experimental capacity at 927 mAh/g, i.e. a yield of 127% compared |
| obtained according | | | to the theoretical capacity of a composition CF_{0.68} |
| to the process of | | | Measured maximum capacity at 1329 mAh/g, i.e. a yield of 181% compared |
| Example 1, | | | to the theoretical capacity of a composition CF_{0.68} |
| grinding for 6 | | | Considering the corrected composition after grinding CF_{0.31} and the |
| hours under argon | | | corresponding theoretical capacity (464 mAh/g), the average yield is 200% |
| | | | and the maximum yield is 286% |

These different experiments show that the ohmic drop is limited or non-existent with the materials of some embodiments. Thus, batteries made using a material according to some embodiments are immediately operational. The potential has been increased to 2.75 V with the materials of some embodiments.

The NMR analyses show a defluorination during grinding. However, the electrochemical properties of the materials are markedly enhanced or improved thanks to the process of some embodiments.

A limitation of heating of the battery is also observed thanks to the materials of some embodiments, as well as enhanced or improved battery life and power, which allows them to be the material of choice for the manufacture of a new generation of batteries, including batteries that must operate at high temperatures, for example at temperatures ranging from 150 to 180° C., or at a low temperature, for example at −20° C.

### Example 4: Analysis by SEM Imaging of a Material Obtained According to the Process of Some Embodiments

During grinding, the grains of powder are highly stressed: they deform and some break, while others stick together. The combined action of this plastic deformation, breakage and sticking together leads to the formation of very homogenous powders consisting of or including agglomerates.

In the case of the materials obtained by the process of some embodiments, for example a material CF_{0.51}, the fluorinated carbon nanofibers are still visible, despite the presence of some agglomerates, as shown by the scanning electron microscope (SEM) image in the accompanying FIG. 11.

These agglomerates have an average size of 1.65 μm. In FIG. 11, it will be noted that the fibers are badly damaged: they are broken, cracked and some are open and reduced to small pieces. For this material of some embodiments, three main classes of fibers are identified after grinding: i) those smaller than 1 μm ii) those between 1 and 3 μm and iii) those larger than 3 μm. The most numerous are the fibers smaller than 1 μm accounting for 50 to 70%, i.e. about 60% in all of the SEM images analyzed, and those between 1 and 3 μm constitute 20 to 40%, i.e. around 30% of the populations represented, and those larger than 3 μm represent from 5 to 15% in general, i.e. around 10% of the populations represented.

### Example 5: Effect of Variations in Certain Grinding Conditions when Implementing the Process of Some Embodiments

According to the protocol described in Example 1, other materials according to some embodiments are made by varying the degree of fluorination and/or the grinding time and/or the grinding speed and/or the grinding cycles and/or the grinding temperature in order to obtain different fluorinated materials according to some embodiments, having a degree of fluorination CFx where x ranges from 0.2 to less than 1.

For example, the experiments with the following parameters are implemented, without being vertically related to each other:

| | Variation of | | |
|---|---|---|---|
| | grinding speed | | |
| | Examples: | 350 rpm | 450 rpm |
| Grinding | Grinding times | 6 hours | 12 hours |
| parameters | Examples: | | |
| | Quantities of | 0.2 g | 2 g |
| | materials ground | | |
| | Examples: | | |
| | Atmospheres | Air | Argon |
| | Examples: | | |

Measurements on the materials are made using a device such as that described in Example 2:
CF_{0.51} Qₜₕₑₒ 1=630 mAh/g
LiPF₆ PC-EC-3DMC 1M
Relaxation: 5 h
Current Density: 10 mA/g

The following observations are made regarding the materials currently obtained:
Importance of the grinding atmosphere: the best performance in terms of capacity is achieved when grinding is performed under an argon atmosphere, possibly fluorinated or under a fluorinated atmosphere;
The grinding time must be longer in the case of fluorinated nanofibers that have a higher fluorination rate;
An enhancement or improvement is observed in discharge potential, limitation of ohmic drop and increase in capacity under air and in argon, for ground fibers;
Grinding times from 5 to 10 hours are advantageous, even more so with grinding cycles such as those defined in some embodiments;
Advantageous grinding speeds of 300 to 500 rpm (rotations per minute).

### Example 6: Laboratory Battery/Button Battery Comparative Experiments

The material obtained according to Example 1 was placed in suspension as described in Example 2, except that the battery used differed because button batteries were used.

FIG. 9 shows the discharge curves obtained with a laboratory battery (square ▪) and a button battery (solid black line).

A high discharge potential of around 2.8 V was observed in the button battery, with a very limited ohmic drop, which confirms the enhanced or improved electrochemical properties of the materials of some embodiments.

The ¹³C NMR analyses show a defluorination of the fluorinated nanofibers during grinding, which implies a reduction in the fluorination rate F/C and theoretical capacity of the material.

An increased extra-capacity and enhanced or improved electrochemical performance are achieved for laboratory batteries and an extra-capacity is for this reason observed in the button battery.

### Example 7: Study of Mechanical Grinding Parameters: Modeling of Grinding and Forces Exerted Using the Process of Some Embodiments

The grinder used in this example is a planetary ball mill, which produces mechanical stresses of the frictional impact type. The starting materials are comparable to those of Example 3 above, namely CF_{0.43} and CF_{0.76} versus CF_{0.31} and CF_{0.68} in Example 3.

The balls exert a centrifugal force that is determined on the one hand from characteristics specific to the latter, namely their mass, density, diameter, etc., and on the other hand from grinding conditions and accessories, in particular rotation speed and diameter of the bowl, and lastly taking account of the physicochemical characteristics of the material to be ground, in particular the diameter of the particles or fluorinated nanofibers and their stiffness.

From this force, and using the mechanical formula described below, the pressure of a ball on a particle to be ground can be determined in order to model what happens during the implementation of some embodiments.

$$contact surface = circle with radius “ a ”$$

$$a = 0.88 . \sqrt[3]{\frac{P}{2} \cdot \frac{\frac{1}{{E}_{1}} + \frac{1}{{E}_{2}}}{\frac{1}{{d}_{1}} + \frac{1}{{d}_{2}}}}$$

$$maximum pressure {P}_{max} = 1.5 . \frac{P}{π {a}^{2}}$$

$$matching of the centers of the spheres$$

$$λ = 0.77 . \sqrt[3]{2. {P}^{2} . {( \frac{1}{{E}_{1}} + \frac{1}{{E}_{2}} )}^{2} . ( \frac{1}{{d}_{1}} + \frac{1}{{d}_{2}} )}$$

a [m]: radius of the contact disc between the 2 spheres
P [N]: pressure exerted on the sphere
E [MPa]: the Young's moduli of the materials making up the spheres
d [m]: diameters of the spheres
λ (lambda) [m]: crushing/sinking/matching of the centers of the spheres during contact

Three ball diameters were studied: 10 mm-15 mm-20 mm, which corresponds to respective pressures of about 1×10⁶ Pa, 2×10⁶ Pa and 4×10⁶ Pa.

Four different grinding durations were studied: 3 h, 6 h, 12 h and 18 h.

A speed of 350 rpm was set for all of the experiments.

In light of the electrochemical performance obtained in this example, optimal grinding conditions for fluorinated nanofibers with a fluorination rate F/C≈0.4 were determined in the context of this example:
Duration: 12 h
Pressure (ball diameter): 1×10⁶ Pa (10 mm).

For fluorinated nanofibers with a fluorination level F/C≈0.8, the optimal grinding conditions were:
Duration: 6 h
Pressure (ball diameter): 1×10⁶ Pa (10 mm).

### Example 8: Characterization of a Product Obtained Using the Process of Some Embodiments, from Photos as Shown in FIGS. 3 and 4: Statistical Analysis of the Obtained Materials: % of Each of the Essential Component Elements of these Materials Obtained by Grinding (Sizes, Shapes, % s)

During grinding, the grains of powder are highly stressed: they deform, and some break, while others stick to each other. The combined action of this plastic deformation, breakage and sticking together leads to the formation of very non-homogenous powders consisting of or including agglomerates.

In the case of the materials obtained by the process of some embodiments, for example a material CF_{0.51}, the fluorinated carbon nanofibers are still visible, despite the presence of some agglomerates, as shown by the scanning electron microscope (SEM) image in the accompanying FIG. 11.

These agglomerates have an average size of 1.65 μm. In FIG. 11, it will be noted that the fibers are badly damaged: they are broken, cracked and some are open and reduced to small pieces. For this material of some embodiments, three main classes of fibers are identified after grinding: i) those smaller than 1 μm; ii) those between 1 and 3 μm; and iii) those larger than 3 μm.

The most numerous are the fibers smaller than 1 μm accounting for 50 to 70%, i.e. about 60% in all of the SEM images analyzed, and those between 1 and 3 μm constitute 20 to 40%, i.e. around 30% of the populations represented, and those larger than 3 μm represent from 5 to 15% in general, i.e. around 10% of the populations represented.

### Example 9: Additional Grinding Experiments Under Fluorinated Atmosphere=Grinding Under Fluorine of the Material Dynamically Sub-Fluorinated According to the Process of Some Embodiments

Post-fluorination experiments were conducted on materials comparable to those of Example 3, and the electrochemical performance of the materials was studied.

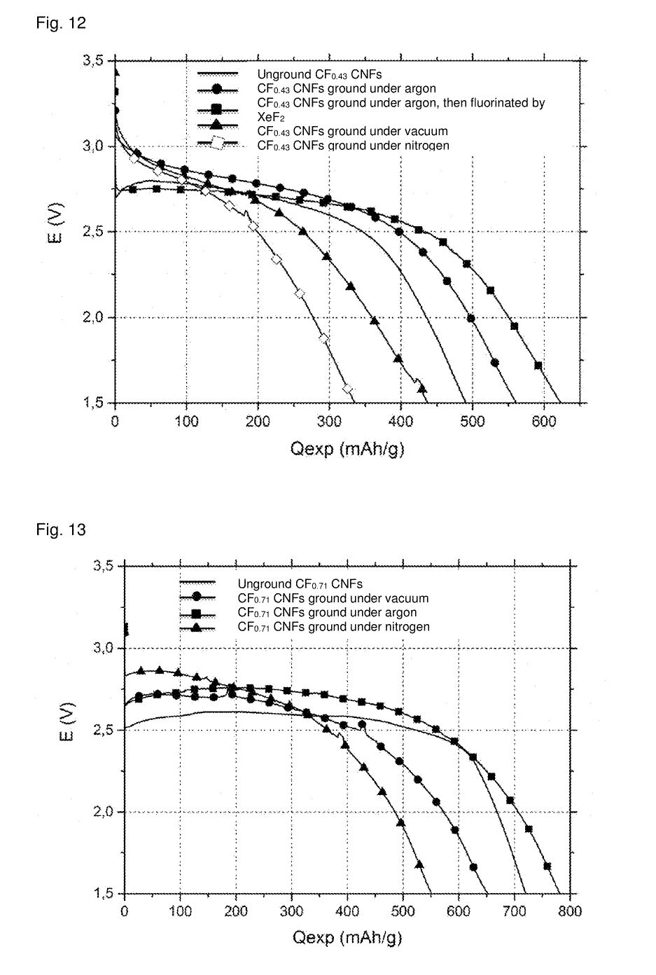

The appended FIG. 12 shows the performance for CF_{0.43} ground for 12 h at a pressure of 1×10⁶ Pa under different atmospheres. In particular, galvanostatic discharge curves are shown at 10 mA/g of the CF_{0.43} fluorinated nanofibers, not ground (solid curve) and ground under different atmospheres for 12 h at 350 rpm under a pressure of 1×10⁶ Pa (under vacuum (solid triangle), argon (solid circle), nitrogen (diamond), post-fluorination with XeF₂ (solid square)).

The best performance observed in these experiments was under argon atmospheres.

The inventors of the presently disclosed subject matter have observed that post-fluorination enhances or improves the performance in terms of the experimental capacity obtained, the fluorination level having slightly increased. Indeed, fluorination by XeF₂ done after grinding induces a surface fluorination of the nanofibers that have been broken or been reduced to small pieces. The intrinsic carbon (not fluorinated) initially located in the core of the fiber is brought back to the surface during grinding and is more accessible to the atomic fluorine derived from the XeF₂ fluorinating agent. This surface “re-fluorination,” slight but nevertheless present, makes it possible to increase the fluorination level of the ground material and thus explains how a higher capacity is obtained. The ohmic drop remains limited relative to the non-ground fibers (black curve) of the related art but is more pronounced than for the grinding done under argon, vacuum or nitrogen according to the process of some embodiments.

For the ground CF_{0.71} (comparable to the CF_{0.8}) CNFs (6 h at 1×10⁶ Pa, speed 350 rpm), the same tendencies were observed, as shown in the appended FIG. 13. In this figure, the galvanostatic discharge curves at 10 mA·g⁻¹ of the CF_{0.71} CNFs, not ground (solid curve) and ground under different atmospheres for 6 h at 350 rpm under a pressure of 1×10⁶ Pa (under vacuum (solid circle), argon (solid square), nitrogen (solid triangle)).

### Example 10: Reproducibility of the Performance Enhancements or Improvements

The observed extra capacity was visible and repeated on batteries of the Swagelok type, i.e. laboratory batteries and button batteries (industrial batteries).

The inventors of the presently disclosed subject matter reproduce the experimental results in a button battery, since the performance in general is more reproducible, but above all because these are industrial batteries.

A study seeking to study the performance of the material on a larger volume was carried out. Thus, a first batch of ground fluorinated CNFs F/C≈0.8 was synthesized in a 50 ml (1.5 g) bowl, then a second batch in a 250 ml (10 g) bowl.

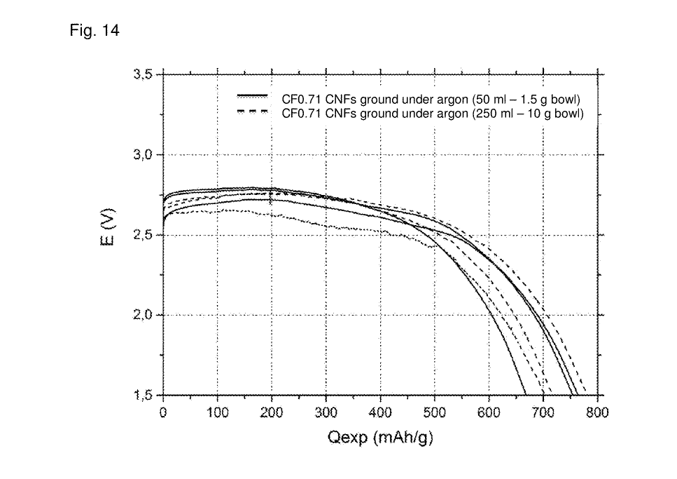

The electrochemical performance is comparable to that observed in all of the experiments done relative to some embodiments, including those described above, for the two aforementioned batches, as shown in the appended FIG. 14.

On average, the discharge potential is 2.6 V for both batches. The average capacity for the small batch (50 ml) is 730 mAh/g and 732 mAh/g for the large batch (250 ml). The results are therefore comparable when the volumes are increased.

The extra capacity phenomenon was not observed on the selected materials, but they nevertheless have a good experimental capacity, equal or close to the theoretical capacity of the non-ground material, a smaller or non-existent ohmic drop, and a high discharge potential compared to the non-ground fluorinated nanofibers of the related art.

### LIST OF REFERENCES

[1] Zhang et al., New synthesis methods for fluorinated carbon nanofibres and applications, Journal of Fluorine Chemistry, 131, 2010, 676-683.
[2] Carbon nanofibres fluorinated using TbF4 as fluorinating agent. Part II: Adsorption and electrochemical properties, Carbon, 46, 2008, 1017-1024.
[3] Zhang et al., Carbon nanofibres fluorinated using TbF4 as fluorinating agent. Part I: Structural properties, Carbon, 46, 2008, 1010-1016.
[4] Synthesis and Characterization of Highly Fluorinated Graphite Containing sp² and sp³ Carbon, K. GUERIN, J. P. PINHEIRO, M. DUBOIS, Z. FAWAL, F. MASIN, R. YAZAMI & A. HAMWI, Chemistry of Materials, 16 (2004) 1786-1792.
[5] NMR and EPR studies of room temperature highly fluorinated graphite heat-treated under fluorine atmosphere, M. DUBOIS, K. GUERIN, J. P. PINHEIRO, F. MASIN, Z. FAWAL & A. HAMWI, Carbon, 42(10) (2004) 1931-1940.
[6] Ahmad et al, Pushing the theoretical limit of Li—CFx batteries using fluorinated nanostructured carbon nanodiscs, Carbon, 94 (2015) 1061-1070.
[7] F. Chamssedine, Marc Dubois, Katia Guérin, J. Giraudet, F. Masin, D. A. Ivanov, L. Vidal, R. Yazami, and A. Hamwi, Reactivity of Carbon Nanofibers with Fluorine Gas, Chem. Mater., 2007, 19 (2), pp 161-172.
[8] Nathalie LORRAIN, Thèse, Université Joseph Fourier, Grenoble I, Poudres nanocomposites: Ag—SnO2 préparées par broyage réactif. Mise en oeuvre, frittage et évolution microstructurale; 2-GILMAN P. S. and NIX W. D., Metall. Trans., 12A 1981, 813-824.

1. A method of manufacturing a material for an electrochemical cell, the process comprising:
grinding fluorinated carbon nanofibers having the formula CFx with 0.2<x<1, the grinding being achieved by frictional impacts for a period of 2 to 100 hours, with a grinding pressure on the particles ranging from 0.29×10⁶ Pa to 4.8×10⁶ Pa.

2. The method according to claim 1, wherein the grinding is performed under vacuum or under a neutral, or fluorinated atmosphere.

3. The method according to claim 1, wherein the grinding is performed at a temperature from 0 to 15° C. and from 55 to 60° C.

4. The method according to claim 1, wherein the fluorinated carbon nanofibres having the formula CFx with 0.2<x<1 have a diameter from 110 to 170 nm and a length from 5 to 9 μm, the central non-fluorinated carbon part of which represents from 3 to 65% by volume of the volume of nanofibres, and whose ¹³C MAS NMR spectrum has a chemical shift band of 120 to 135 ppm/tetramethylsilane (TMS).

5. The method according to claim 1, wherein the grinding includes an alternation of periods of grinding (B) and pausing (P) without grinding, with B being between 1 second and 100 hours and P also being between 1 second and 100 hours respectively.

6. A material for an electrochemical cell obtained according to the process of claim 1.

7. An electrode, comprising:
the material according to claim 6.

8. A battery, comprising:
the electrode according to claim 7.

9. The battery according to claim 8, the battery being a lithium battery.

10. The battery according to claim 8, the battery being a button battery, a laboratory battery, a cylindrical battery, or a spiral-wound battery.

11. A device, comprising:
the battery according to claim 8.

12. The device according to claim 11, the device being one of a portable telephone, a meter, oil drilling communication equipment, a pressurized device, a low or high temperature device, a watch, a pacemaker, a drug or medication injector, or a neuro-stimulator.

13. The method according to claim 2, wherein the grinding is performed at a temperature from 0 to 15° C. and from 55 to 60° C.

14. The method according to claim 2, wherein the fluorinated carbon nanofibres having the formula CFx with 0.2<x<1 have a diameter from 110 to 170 nm and a length from 5 to 9 μm, the central non-fluorinated carbon part of which represents from 3 to 65% by volume of the volume of nanotubes, and whose ¹³C MAS NMR spectrum has a chemical shift band of 120 to 135 ppm/tetramethylsilane (TMS).

15. The method according to claim 3, wherein the fluorinated carbon nanofibres having the formula CFx with 0.2<x<1 have a diameter from 110 to 170 nm and a length from 5 to 9 μm, the central non-fluorinated carbon part of which represents from 3 to 65% by volume of the volume of nanotubes, and whose ¹³C MAS NMR spectrum has a chemical shift band of 120 to 135 ppm/tetramethylsilane (TMS).

16. The method according to claim 2, wherein the grinding includes an alternation of periods of grinding (B) and pausing (P) without grinding, with B being between 1 second and 100 hours and P also being between 1 second and 100 hours respectively.

17. The method according to claim 3, wherein the grinding includes an alternation of periods of grinding (B) and pausing (P) without grinding, with B being between 1 second and 100 hours and P also being between 1 second and 100 hours respectively.

18. The method according to claim 4, wherein the grinding includes an alternation of periods of grinding (B) and pausing (P) without grinding, with B being between 1 second and 100 hours and P also being between 1 second and 100 hours respectively.

19. A material for an electrochemical cell obtained according to the process of claim 2.

20. A material for an electrochemical cell obtained according to the process of claim 3.
